(19) United States
(12) Patent Application Publication
(10) Pub. No.: US 2026/0155762 A1
(43) Pub. Date: Jun. 4, 2026

(54) Systems And Methods For Virtual Droop Control

(71) Applicant: BLOOM ENERGY CORPORATION, San Jose, CA (US)

(72) Inventors: Chaitanya Mandela, Bangalore (IN); Ranganathan Gurunathan, Bangalore (IN); Ayyappa Rudrasimha Yedida, Bangalore (IN); Saravanakumar Narayanasamy, Bangalore (IN); Vishal Anand Aisur Gopalakrishnan, Bangalore (IN); Badrinarayanan Thiruvengadaswamy, Bangalore (IN); Beau E. Baker, San Jose, CA (US); Vignan Reddy Bommireddy, San Jose, CA (US); Mehdi Ebad, San Jose, CA (US)

(21) Appl. No.: 19/406,326

(22) Filed: Dec. 2, 2025

Related U.S. Application Data
(60) Provisional application No. 63/727,037, filed on Dec. 2, 2024.

(51) Int. Cl. H02M 7/5387; H02J 3/38; H02M 1/00

(52) U.S. Cl. CPC H02M 7/53875; H02J 3/38; H02M 1/0012; H02M 1/0025

(57) ABSTRACT

A method includes applying a first proportional gain constant (Kₚ₁) and a first integral gain constant (Kᵢ₁) to a difference based on a reference voltage and an output voltage of an inverter to generate a virtual current signal for an inner current loop, where Kₚ₁ is associated with a resistive component of an emulated impedance, and where Kᵢ₁ is associated with an inductive component of the emulated impedance. The method also includes controlling the output voltage of the inverter based on the virtual current signal.

### CROSS-REFERENCE TO RELATED APPLICATIONS

This application claims priority to and the benefits of U.S. Provisional Patent Application No. 63/727,037 filed on Dec. 2, 2024, which is incorporated herein by reference in its entirety.

### TECHNICAL FIELD

The present disclosure relates to control systems and methods for a grid-forming inverter.

### BACKGROUND

Electrical power systems can be used to provide electrical power to one more loads such as buildings, appliances, lights, tools, air conditioners, heating units, factory equipment and machinery, power storage units, computers, data centers, security systems, and the like. The electricity used to power loads is often received from an electrical grid.

Microgrids include multiple, paralleled energy sources to provide power to a load. The energy sources may include synchronous machines, direct current (DC) energy sources (e.g., solar cells), or a combination thereof. In alternating current (AC) microgrids, inverters may be coupled to the DC energy source(s) to perform DC-to-AC conversion to provide AC power to the load.

A microgrid can also be integrated into the electrical grid infrastructure. Thus, the energy sources of the microgrid can be used in conjunction with the electrical grid, and a plurality of energy sources may be combined in a single electrical power system to provide electrical power to one or more loads.

### SUMMARY

In an embodiment of the present disclosure, a method includes applying a first proportional gain constant (Kₚ₁) and a first integral gain constant (Kᵢ₁) to a difference based on a reference voltage and an output voltage of an inverter to generate a virtual current signal for an inner current loop, where Kₚ₁ is associated with a resistive component of an emulated impedance, and where Kᵢ₁ is associated with an inductive component of the emulated impedance. The method also includes controlling the output voltage of the inverter based on the virtual current signal.

In another embodiment of the present disclosure, a method includes applying a first proportional gain constant (Kₚ₁) and a first integral gain constant (Kᵢ₁) to a difference based on a reference voltage and an output voltage of an inverter to generate a virtual current signal, where Kₚ₁ is associated with a resistive component of an emulated impedance, and where Kᵢ₁ is associated with an inductive component of the emulated impedance. The method also includes providing the virtual current signal to a frequency-based control loop, where the frequency-based control loop controls a frequency of the inverter based on the virtual current signal and a first reference power value; and providing the virtual current signal to a multiplier-based control loop, where the multiplier-based control loop controls an output power of the inverter based on the virtual current signal and a second reference power value.

In yet another embodiment of the present disclosure, a microgrid includes a power source, a load, and an inverter electrically coupled to the power source and configured to provide an output voltage to the load, where the inverter includes a controller configured to: apply a first proportional gain constant (Kₚ₁) and a first integral gain constant (Kᵢ₁) to a difference based on a reference voltage and the output voltage of the inverter to generate a virtual current reference signal for an inner current loop of the controller, where Kₚ₁ is associated with a resistive component of an emulated impedance, and where Kᵢ₁ is associated with an inductive component of the emulated impedance; and control the output voltage of the inverter based on the virtual current signal.

In still another embodiment of the present disclosure, a microgrid includes a power source, a load, and an inverter electrically coupled to the power source and configured to provide an output voltage to the load, where the inverter includes a controller configured to: apply a first proportional gain constant (Kₚ₁) and a first integral gain constant (Kᵢ₁) to a difference based on a reference voltage and an output voltage of an inverter to generate a virtual current signal, where Kₚ₁ is associated with a resistive component of an emulated impedance, and where Kᵢ₁ is associated with an inductive component of the emulated impedance; provide the virtual current signal to a frequency-based control loop, where the frequency-based control loop controls a frequency of the inverter based on the virtual current signal and a first reference power value; and provide the virtual current signal to a multiplier-based control loop, where the multiplier-based control loop controls an output power of the inverter based on the virtual current signal and a second reference power value.

Further embodiments of the present disclosure may also include a system as substantially described herein, a method as substantially described herein, or a controller for a grid-forming inverter as substantially described herein.

Embodiments described herein include a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the concepts and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic illustration of a circuit model of a grid-forming inverter;

FIG. 2 is a schematic illustration of a droop control implementation for a grid-forming inverter;

FIG. 3 is a schematic illustration of a closed control loop model of droop control for a grid-forming inverter;

FIG. 4 is a schematic illustration of a circuit model of a two-source model equivalent for a grid-connected voltage source;

FIG. 5 is a schematic illustration of the circuit model of FIG. 4 in response to an overload condition that causes a loss of synchronization;

FIG. 6 is a schematic illustration of a power control loop in accordance with an embodiment of the present disclosure;

FIG. 7 is a schematic illustration of a voltage control loop for a grid-forming inverter in accordance with an embodiment of the present disclosure;

FIG. 8 is a circuit model of a parallel resistor-inductor (RL) circuit;

FIG. 9 is a schematic illustration of a voltage control loop with a multiplier (K) in accordance with an embodiment of the present disclosure;

FIG. 10 is a schematic illustration showing an approximation of the inner current loop of FIG. 9 in a voltage control loop with a multiplier (K) in accordance with an embodiment of the present disclosure;

FIG. 11 is a circuit model of an effective virtual impedance network in accordance with an embodiment of the present disclosure;

FIG. 12 is a schematic illustration comparing conventional droop control with virtual droop control in accordance with an embodiment of the present disclosure;

FIG. 13 is a schematic illustration of virtual power measurement in accordance with an embodiment of the present disclosure;

FIG. 14 is a schematic illustration comparing conventional droop control with virtual droop control in current limiting mode in accordance with an embodiment of the present disclosure;

FIG. 15 is a circuit model of an analog implementation of a proportional-integral (PI) controller in accordance with an embodiment of the present disclosure;

FIG. 16 is a schematic illustration of active and reactive power control loops with the multiplier (K) in accordance with an embodiment of the present disclosure;

FIG. 17 is a schematic illustration of maximum power frequency and multiplier loops in accordance with an embodiment of the present disclosure;

FIG. 18 is a schematic illustration of initial synchronization enabled by virtual droop control in accordance with an embodiment of the present disclosure;

FIG. 19 is a schematic illustration of virtual droop control operation before and after closing a circuit breaker coupled to a grid-forming inverter in accordance with an embodiment of the present disclosure;

FIG. 20 is a schematic illustration of a virtual impedance network on an isolated grid in accordance with an embodiment of the present disclosure;

FIG. 21 is a schematic illustration of virtual droop control implemented on an isolated source/grid in accordance with an embodiment of the present disclosure;

FIG. 22 is a graphical illustration of power control through offset adjustment; and

FIG. 23 is a schematic illustration of a hybrid droop control implementation in accordance with an embodiment of the present disclosure.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean within 10% (i.e., plus or minus 10%) of the recited value. Thus, for example, a recited voltage of “about 5 volts” refers to a voltage ranging from 4.5 volts to 5.5 volts.

Droop control is a technique for regulating voltage and frequency of energy sources (or the inverters coupled thereto) by inherently regulating reactive power and active power, which can be sensed locally, based on certain AC droop curves. For example, an inverter controller senses the output voltage of an inverter and controls the output voltage independently based on the AC droop curves. Applying droop control across the microgrid sources (e.g., grid-forming inverters) enables synchronization and power sharing among the various energy sources.

However, droop control achieves synchronization between multiple grid-connected sources based on negative feedback derived from circulating power between those sources. During a short circuit condition (e.g., a bolted short circuit or low-impedance short circuit at the inverter output), the negative feedback conventionally relied upon for droop control is unavailable. As a result, during such a short circuit condition, the frequency of the source (e.g., inverter) may drift from the grid frequency, resulting in a phase shift. When the short circuit condition is rectified, the integrated phase shift between the sources may result in a relatively large circulating power between grid-connected sources, which may in turn result in a grid voltage and/or frequency collapse. In the event of such a collapse, it may be necessary to perform various remedial measures, such as shutting down or restarting the microgrid (e.g., a “black start”). Accordingly, it is useful to implement a control in conjunction with droop control that limits or arrests such circulating currents, thus protecting the connected source(s) of the microgrid from experiencing overload/negative power conditions that may lead to the failure of microgrid.

Embodiments of the present disclosure address the foregoing by providing a voltage control loop (e.g., for an inverter) that applies a proportional-integral (PI) controller to a difference between a reference voltage and an output voltage of the inverter. The PI controller mimics or emulates an impedance, where the proportional gain constant of the PI controller is associated with a resistive component of the emulated impedance (e.g., Kₚ₁=1/R), and where the integral gain constant of the PI controller is associated with an inductive component of the emulated impedance (e.g., Kᵢ₁=1/L). The output of the PI controller is referred to as a virtual current signal, and is provided to the inner current control loop as a current reference. The PI controller is designed such that the virtual current signal closely approximates the real output current of the inverter in both steady-state and transient conditions. In at least some embodiments, a current sensor at the output of the inverter is not needed, and thus can be eliminated from the inverter design.

The virtual current signal may be used to control the output voltage of the inverter, such as by providing the virtual current to an inner current loop as a reference current input. The inner current loop is generally conventional, and receives current feedback from a current sensor for an inverter filter, rather than an output current sensor.

In other embodiments, a virtual power signal is generated based on the virtual current signal (instead of an actual current signal) and the output voltage of the inverter. The virtual power signal may be provided to a droop controller, which allows droop control to be implemented (i.e., controlling the output frequency and voltage of the inverter) even when recovering from a short circuit condition.

In another embodiment, the virtual power signal may also be generated based on the virtual current signal and a grid voltage, such as when the inverter is electrically decoupled from the grid. The virtual power signal being based on the grid voltage allows the droop controller to synchronize the inverter output frequency and voltage with the grid prior to the inverter being coupled to the grid. Subsequently, once the inverter output frequency and voltage approximately match the grid frequency and voltage, respectively, the inverter can be coupled to the grid (e.g., by closing a breaker between the inverter and the grid).

In all of the above embodiments, the risks associated with phase shifts in frequency between the inverter and the grid may be mitigated by using the virtual current signal (and its underlying emulated impedance) instead of an actual current provided by the inverter. These and other embodiments are described more fully below, with reference made to the accompanying figures.

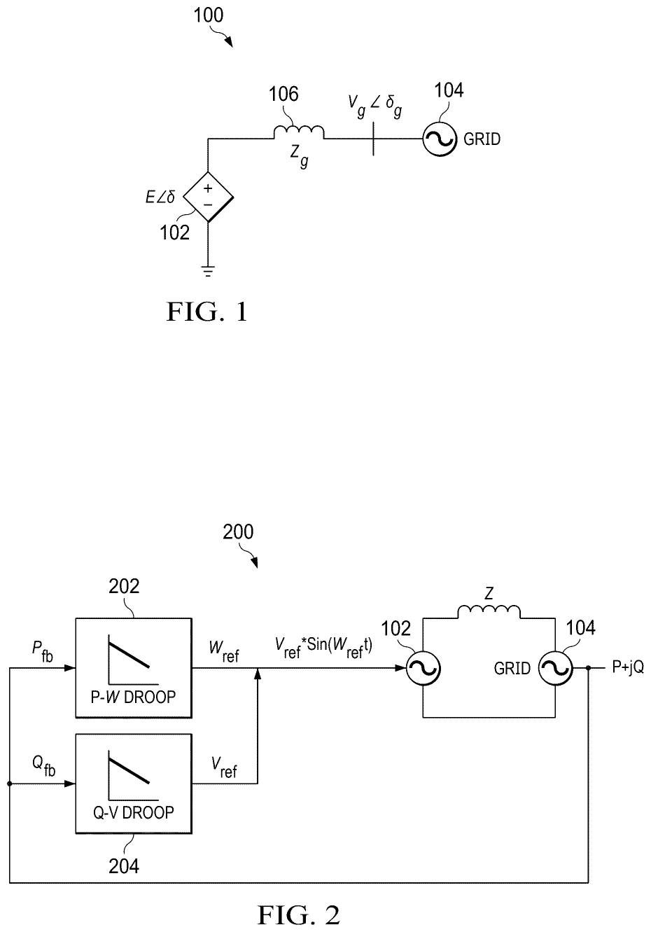

FIG. 1 is a schematic illustration of a circuit model 100 of a grid-forming inverter (also referred to simply as an inverter, for brevity). As explained above, droop control is a technique for synchronization and power sharing in grids and microgrids. Droop control works on the basic principle of power flow between two voltage sources, where the two sources can be a grid-forming inverter and a grid/microgrid formed by a combination of paralleled sources as shown in FIG. 1. In the circuit model 100, the grid-forming inverter is represented by a voltage source 102, while the grid/microgrid (also referred to simply as a grid, for brevity) is represented by an AC voltage source 104. The inverter 102 thus forms a grid/islanded grid by acting as a voltage source connected to the grid/microgrid/load 104 through an impedance 106. The impedance 106 may be grid impedance, source (i.e., inverter) impedance, or a combined impedance of both the grid and the source.

In FIG. 1, E<δ represents the inverter 102 voltage vector, V_{g}<δ_{g} represents grid 104 voltage vector, and Z_{g} is the impedance 106 between the inverter 102 and the grid 104. The active power (P) and reactive power (Q) flow are given by power swing equations:

$$P = \frac{E}{{Z}_{g}} ( E cos θ - {V}_{g} cos ( θ + δ - {δ}_{g} ) ) \qquad Equation 1$$

$$Q = \frac{{V}_{g}}{{Z}_{g}} ( E sin ( θ + δ - {δ}_{g} ) - {V}_{g} sin θ ) \qquad Equation 2$$

In Equations 1 and 2, E is the magnitude of the voltage of the inverter 102 and V_{g} is the magnitude of the voltage of the grid 104, Zg is the magnitude of the impedance 106, θ is the phase angle of the impedance 106, and δ−δ_{g} represents the phase angle difference between sources (e.g., grid and inverter).

At the grid level, the impedance 106 is predominantly inductive, and thus the real power and reactive power flow are characterized by the phase and voltage differences, respectively, between the inverter 102 and the grid 104. Assuming that the impedance 106 is predominantly inductive, the active and reactive power exported to grid 104 from Equations 1 and 2 can be rewritten as:

$$P = \frac{E * {V}_{g} sin ( δ - {δ}_{g} ) )}{{X}_{g}} \qquad Equation 3$$

$$Q = \frac{{V}_{g} * ( E cos ( δ - {δ}_{g} ) - {V}_{g} )}{{X}_{g}} \qquad Equation 4$$

In Equations 3 and 4, X_{g} is the reactive component of impedance Z_{g}, because of the predominantly inductive nature of the impedance 106. The power angle (δ−δ_{g}) is a function of frequency difference between the source 102 and the grid 104. For small values of power angle (δ−δ_{g}) Equation 3 can be rewritten as:

$$P = \frac{E * {V}_{g}}{{X}_{g}} * \int ( {ω}_{s} - {ω}_{g} ) d t \qquad Equation 5$$

Where ωₛ and ωg are source and grid frequency, respectively. From Equations 4 and 5, it can be seen that the active power (P) exported to the grid 104 can be controlled by controlling the frequency of the grid-forming inverter 102 (which indirectly controls the phase), while the reactive power (Q) exported to the grid 104 can be controlled by controlling the voltage of the grid-forming inverter 102.

FIG. 2 is a schematic illustration of a droop control implementation 200 for a grid-forming inverter. As explained above, grid-forming inverters and synchronous machines typically employ droop control to maintain synchronization with the grid, where the frequency and voltage references of the inverter are derived from active and reactive power feedback, respectively.

A first droop curve 202 is applied to the active power feedback component from the grid 104, and provides a reference frequency (w_{ref}) based on the active power component. A second droop curve 204 is applied to the reactive power feedback component from the grid 104, and provides a reference voltage (v_{ref}) based on the reactive power component. The reference frequency and reference voltage are used to control the behavior of the grid-forming source (e.g., inverter 102).

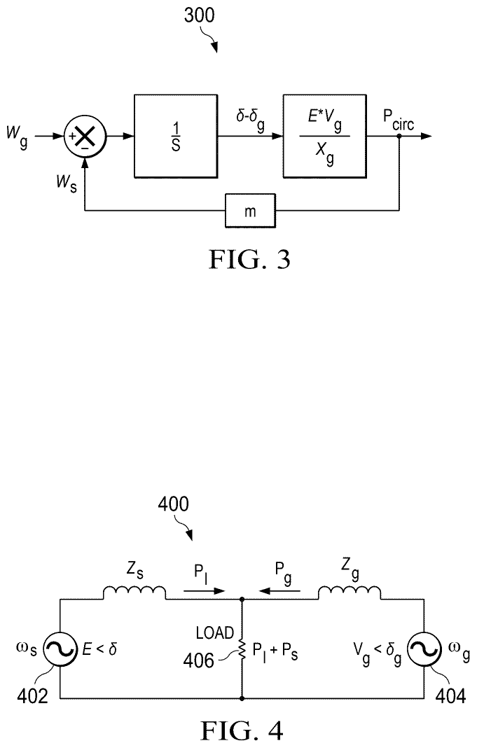

FIG. 3 is a schematic illustration of a control loop 300, which in this example is an inherent closed loop provided by droop control for a grid-forming inverter. In the control loop 300 in FIG. 3, the droop curves form a closed loop by providing negative feedback against the change in frequency/phase through circulating power (P_{circ}), or the power exported to the grid by the inverter. The control loop 300 enables grid-forming sources (e.g., inverter 102) to synchronize with the grid/microgrid while also controlling power as governed by a linear droop equation. Equation 6 is a conventional droop equation that governs the frequency versus active power characteristic of a grid forming source:

$$f = {f}_{nl} - m * {P}_{l} \qquad Equation 6$$

Where fₙₗ is the no load frequency of the grid forming source (e.g., inverter 102) and Pₗ is the load power or power export by the inverter 102.

As explained above, droop control achieves synchronization between multiple grid-connected sources based on negative feedback derived from circulating power between those sources. However, during a short circuit condition (e.g., a bolted short circuit or low-impedance short circuit at the inverter output), the negative feedback conventionally relied upon for droop control is unavailable.

As an illustrative example, FIG. 4 is a schematic illustration of a circuit model comprising a system 400 consisting of a two-source model equivalent of a grid-forming inverter (i.e., voltage source 402) in parallel with a microgrid (i.e., voltage source 404), which are also connected to a load 406 in parallel.

As explained above, the frequency of the inverter 402 (fₛ) is synchronized with the frequency of the microgrid/voltage source 404 based on the correlation between the phase shift between the sources 402, 404 and the power export (Pₗ) due to the inductive nature of the source impedances (Zₛ and Z_{g}).

Unlike synchronous machines, inverters are current-limited, and thus the power flow equation to the load 406 will not remain valid during short circuit/overload conditions, because the assumed voltage source model shown in FIG. 4 is no longer valid when the inverter 402 operates in a current-limited mode.

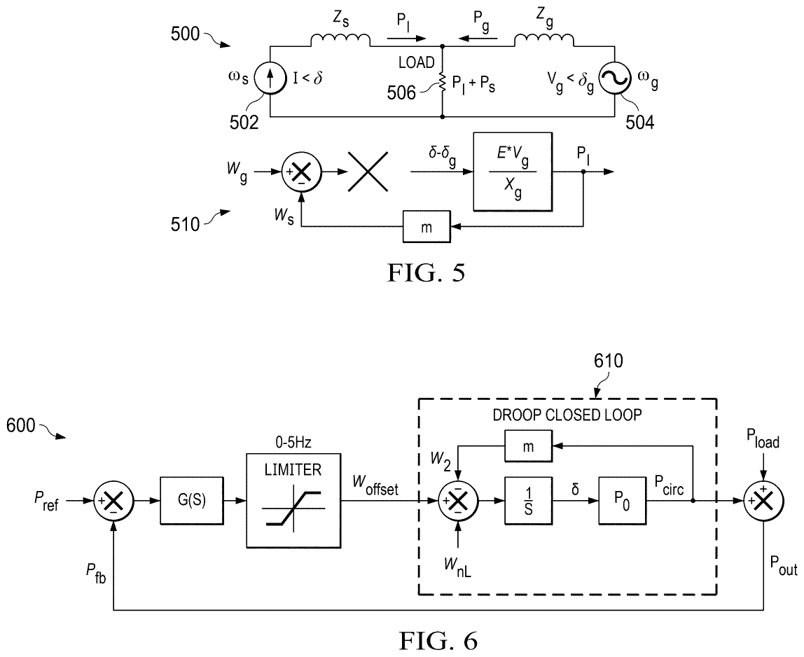

As an illustrative example, FIG. 5 is a schematic illustration of a circuit model comprising a system 500 that is similar to the system 400 of FIG. 4, except that the system 500 schematically illustrates the inverter in current-limited mode (i.e., current source 502). The grid/microgrid is modeled by voltage source 504, and a load 506 is in parallel with the inverter 502 and the voltage source 504. In the system 500, when the inverter 502 is in current-limited mode, power flow Equation 5 is no longer valid, which also breaks the closed loop droop control 510.

Because the negative feedback provided by a droop curve is non-existent during short circuit/overload conditions, the frequency of the source (e.g., inverter 502) may drift from the grid frequency, resulting in a phase shift, particularly in relatively longer-duration short circuit conditions (e.g., greater than 20 fundamental cycles). When the short circuit condition is rectified, the integrated phase shift between the sources may result in a relatively large circulating power between grid-connected sources, which may in turn result in a grid voltage and/or frequency collapse, as well as resultant grid instability. Accordingly, droop control is vulnerable to short circuit/overload conditions because of the possible loss of synchronization when the inverter 502 operates in current-limited mode. One conventional approach is to simply treat sustained short circuit conditions (e.g., greater than 1 second) as a black out condition, which requires various remedial measures, such as shutting down or restarting the microgrid (e.g., a “black start”). However, this would result in load dropping for a relatively significant amount of time, particularly when the microgrid is larger and all connected sources must be brought back online through a resynchronization period.

The closed loop transfer function between the droop frequency and the power export/circulation can be derived from the control loop represented in FIG. 3 is given by:

$$\frac{P ( s )}{ω ( s )} = \frac{{P}_{0}}{s + m {P}_{0}} \qquad Equation 7$$

where the circulating power constant

$$\frac{E * {V}_{g}}{{X}_{g}}$$

is represented by P₀ for brevity. The power exported to the grid by a grid-forming inverter is controlled through frequency, and thus power control loops for the inverter (e.g., maximum power control loop, minimum power control loop) may implement a PI controller having an output that adjusts the frequency/offset of a droop curve based on the set point.

FIG. 6 illustrates an exemplary power control loop 600, which includes a droop control closed loop 610 as an inner loop. Thus, the response of the power control loop 600 depends on the droop control inner loop 610. For example, the bandwidth of the droop control inner loop 610 (i.e., mP₀ from Equation 7) affects the bandwidth of the power control loop 600. The bandwidth of the droop control loop as an inner loop would similarly affect any other outer loop, such as a DC bus control loop, a maximum power point tracking (MPPT) control loop, a current control loop, and the like. The bandwidth of the droop control inner loop 610 is limited by the source impedance (which determines P₀), as well as by a sampling rate at which the power feedback is updated (e.g., the droop control bandwidth has to be at least 5 times less than the frequency at which the power feedback is updated). Accordingly, the bandwidth of any control loop that contains the droop control inner loop 610 will also be limited.

In some cases, a pre-filter may be added (e.g., to the power control loop 600) to cancel or compensate for the pole of the droop control inner loop 610. However, such a pre-filter may require accurately modeling various aspects of the microgrid, which may be difficult. For example, the source impedance also includes line impedances, which may be difficult to accurately incorporate into a plant model. Accordingly, it may be useful to decouple droop control loops from other control loops, such as the power control loop 600 shown in FIG. 6.

In general, in a grid/microgrid having multiple sources operating in parallel, bringing a new source online (e.g., connecting the source to the AC bus) requires synchronizing the new source with the AC bus. If a new source is not synchronized with the AC bus prior to being connected to the grid/microgrid, relatively large circulating currents may exist if the source is operated as voltage controlled (i.e., a grid-forming source). This is similar to standard requirements of synchronization controls for synchronous machines.

Even in droop control, initial voltage/phase synchronization information is provided by a phase-locked loop (PLL) until the source gets connected to the AC bus to avoid major phase differences between the AC bus and the voltage generated by the voltage-controlled source. In some cases, it is challenging to switch over between PLL-generated phase and droop control-generated phase, because any phase shifts during such transition result in corresponding, sudden shifts in power/current exported to the grid/microgrid. Accordingly, a control algorithm should seamlessly transition between PLL-generated phase and droop control-generated phase. Also, while switching over to droop control, the feedback of the grid/microgrid contactor becomes important because the droop control will veer away from the AC bus frequency if the grid contactor is open.

As explained above, the closed loop of droop control is enabled through the inherent relationship between frequency difference and the power exported to the grid/microgrid (also referred to herein as circulating power in the case of a two-source model) demonstrated by Equation 5. This relationship depends on source/line impedances between the connected sources, and thus the droop control bandwidth and its subsequent response are also dependent on these impedances. Further, these impedances also govern the stability of droop control, given by the criteria:

$$\frac{E * {V}_{g}}{{X}_{g}} * m * {T}_{update} < 1 \qquad Equation 8$$

in which T_{update} is the rate at which the power feedback is digitally updated in the droop control algorithm.

The power feedback is typically updated at a rate of once per fundamental line cycle, and thus the source impedance X_{g} exerts a limitation on the maximum droop slope (m) that can be achieved. For an inverter having an output impedance that is comparatively less than rotating machine-based power sources, this dependency on impedance imposes a greater limit on the achievable droop curve slope.

The slope of droop curves determines the bandwidth of the droop control loop, and thus the bandwidth of the droop control is improved for higher droop slope values. As a result, the synchronization and power sharing (e.g., responsiveness) between sources is also improved at higher droops. Having a relatively small droop slope (e.g., less than 0.1 Hertz (Hz)) between the no-load and the full-load frequencies will approximate a flat droop curve (i.e., close to 0 slope), and renders the droop control loop ineffective. Accordingly, droop slopes for grid-forming inverters in microgrids are often set in the range of 1-3%, which would be 0.6-1.8 Hz for a 60 Hz system.

The above-described dependencies of droop control on impedance impose a requirement on a source to have an impedance that is governed by the sources/microgrid to which it is connected. For example, Equation 8 imposes a minimum requirement on source impedance in order to achieve a higher droop slope, which constrains the ability to reduce the size of a filter inductor, which is a part of the source impedance. Increasing source impedance increases both cost and size of the source, particularly in case of inverters operating at high switching frequencies, which otherwise would be able to operate with a reduced size filter inductor. Also, additional impedance such as an inductor may need to be added as a supplement to achieve higher droop slopes.

Embodiments of the present disclosure address the limitations of droop control explained above by calculating power without a current sensor (e.g., the inverter controller does not necessarily include an output current sensor). This calculated power may be referred to herein as “virtual power,” because it is not derived directly from a current measurement. Droop control based on such virtual power may be referred to herein as “virtual droop control.” Unlike conventional droop control, which functions based on actual power feedback (i.e., measured output current and voltage, or measured output power), the virtual power is obtained by emulating an impedance that matches the output impedance of the inverter. By matching the virtual impedance to the output impedance of the inverter, or any other source where such virtual droop control is implemented, the power delivered by the inverter (or other source) can be closely estimated irrespective of the line impedances in the grid to which the inverter (or other source) is coupled.

Power flow between any two voltage sources depends on three parameters: magnitude of voltages, phase shift between the sources, and impedance of the sources, as reflected by Equations 3, 4, and 5. A finite impedance is important to control the power flow between various sources connected in a microgrid. In some cases, 5% source impedance is considered to be a standard value for most inverter-based applications. This source impedance may be provided by an output filter inductance of the inverter. However, for inverters that are current controlled, the filter inductor does not affect the source impedance because the inductor current is the control variable, and hence cannot be modelled as the source impedance.

The droop stability criteria provided in Equation 8 demonstrates that system stability improves with higher source impedance. In other words, increasing the source impedance improves droop control stability and reduces short circuit currents. However, introducing a physical impedance (e.g., inductor and/or resistor) to achieve this purpose can be costly and may affect the power density of the inverter because line frequency inductors can be bulky.

The embodiments of the present disclosure, described further below, emulate a source impedance using a nested output voltage control loop (e.g., an outer voltage loop and an inner current loop), which avoids the need to implement such additional physical impedance, while providing improved stability criteria similar to that which would be provided by additional physical impedance.

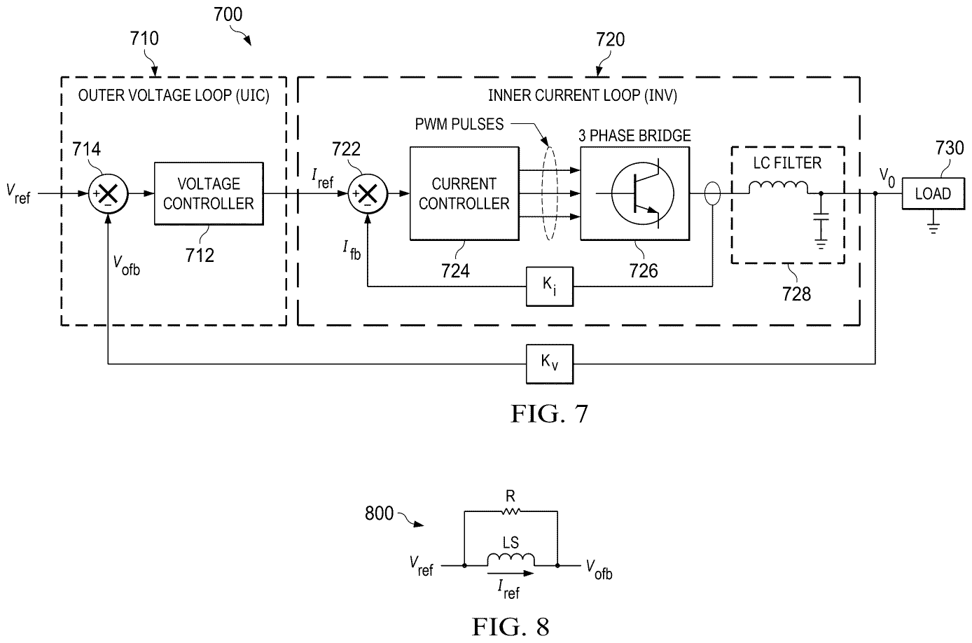

FIG. 7 is a schematic illustration of a voltage control loop 700 for a grid-forming inverter. In general, the control loop 700 may be employed in various inverter/drive applications. In FIG. 7, the voltage control loop 700 includes an outer voltage loop 710 and an inner current loop 720. The outer voltage loop 710 includes an error amplifier 714 that compares a reference voltage v_{ref} to a feedback voltage V_{ofb}. The outer voltage loop 710 also includes a PI controller 712 (voltage controller), which receives the output of the error amplifier 714 as input, and provides an output as a reference to the inner current loop 720 as a current reference (I_{ref}).

The inner current loop 720 includes an error amplifier 722 that compares the current reference to a feedback current signal I_{fb}. An output of the error amplifier 722 is provided to a current controller 724, which controls a 3-phase bridge 726 through pulse width modulated (PWM) signals to generate the required switching voltages. The 3-phase bridge 726 is connected to an inductor-capacitor (LC) filter 728 that filters out the switching frequency components generated by the 3-phase bridge 726 and provides a fundamental frequency voltage (V₀) to load 730. The feedback current signal is based on the current into the LC filter 728, while the feedback voltage is based on the voltage (V₀) to load 730.

The current reference (I_{ref}) generated by the outer voltage loop 710 can be calculated in the Laplace domain as:

$${I}_{ref} ( s ) = \frac{s * {K}_{p} + {K}_{i}}{s} * ( {V}_{ref} ( s ) - {V}_{0 fb} ( s ) ) \qquad Equation 9$$

where, Kₚ and Kᵢ are the proportional and integral gains of PI controller 712 respectively, and ‘s’ is the Laplace operator.

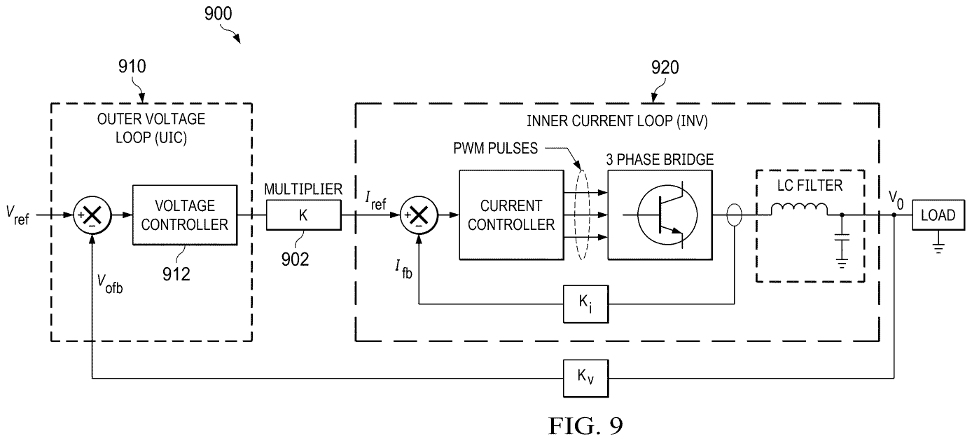

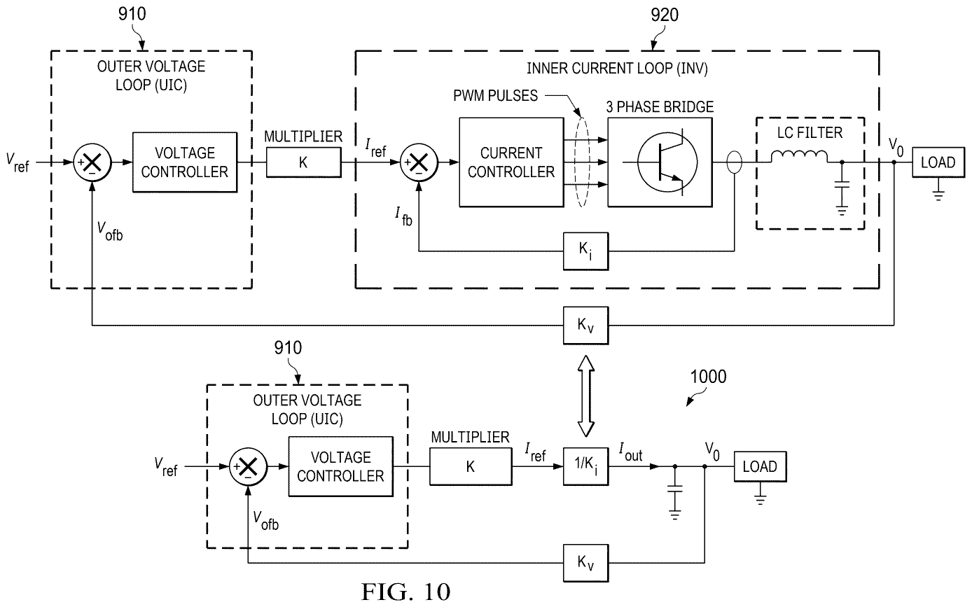

FIG. 8 is a circuit model of a parallel resistor-inductor (RL) circuit 800 coupled between a node at a voltage denoted by v_{ref} and another node at a voltage denoted by V_{ofb}. The current flowing between the nodes of the RL circuit 800 (I_{ref}) is given as:

$${I}_{ref} ( s ) = ( \frac{1}{R} + \frac{1}{L s} ) * ( {V}_{ref} ( s ) - {V}_{0 fb} ( s ) ) \qquad Equation 10$$

Rewriting Equation 10 and comparing with Equation 9 gives:

$${I}_{ref} ( s ) = \frac{s * \frac{1}{R} + \frac{1}{L}}{s} * ( {V}_{ref} ( s ) - {V}_{0 fb} ( s ) ) \qquad Equation 11$$

$${K}_{p} = \frac{1}{R} , {K}_{i} = \frac{1}{L}$$

Accordingly, the PI controller 712 in the nested loop structure of FIG. 7 is configurable to emulate a source impedance, and a particular value of source impedance may be achieved through selection of values for Kₚ and Kᵢ. Also, such emulated impedance is predominantly inductive in nature, which is a typical case with most of the sources connected to a grid/microgrid. The impedance values described herein are scaled/per unit (pu) values calculated at the PI controller 712 level (e.g., typically at signal level corresponding to the voltage ratio (Kᵥ) and current sensor ratio (Kᵢ)), and may need to be scaled accordingly to the inverter power level. In the examples described herein, the reference voltage for the PI controller 712 is v_{ref}, and a scaled appears as the no load voltage of the inverter and the output voltage drops with load version

$$( \frac{{V}_{ref}}{{K}_{v}} )$$

appears as the no load voltage of the inverter and the output drops with load due to the steady state error caused by the limited gain of PI controller 712 at the operating fundamental frequency. This drop is attributed as the voltage drop across the source impedance. For example, as the PI controller 712 regulates the voltage of the inverter, the reference voltage on which the input to PI controller 712 is based is scaled relative to output voltage V₀ by a factor of 1/Kᵥ. Because of the limited gain magnitude of PI controller 712 at the fundamental frequency, the output voltage V₀ tends to drop with load. This voltage drop/behavior is similar to a voltage source with a finite impedance connected to a load. In various embodiments, the PI controllers described herein may be implemented digitally, or in the analog domain, such as by an operational amplifier (op amp)-based circuit.

In the embodiments described herein, emulating the impedance by the voltage control loop (such as exemplary voltage control loop 700 in FIG. 7) enables determining power flow between the inverter and any other voltage source, depending on the phase shift and the voltage difference between the sources. Emulating the impedance in the PI controller eliminates the need for any physical impedance, reducing both cost and space requirements of the inverter.

In some embodiments, a multiplication factor (K) is applied to dynamically control the magnitude of the impedance without changing its phase. For example, K is in the range 0<K<1. FIG. 9 is a schematic illustration of a voltage control loop 900 that includes the multiplier (K) 902 in accordance with an embodiment of the present disclosure. The voltage control loop 900 includes an outer voltage loop 910 and an inner current loop 920, which are similar to the loops 710, 720, respectively, described above with respect to FIG. 7.

Including the multiplier 902 effectively proportionally reduces the parameters Kₚ and Kᵢ of the PI controller 912, which increases the emulated impedance by the same factor. In other words, the emulated impedance can be given as Z/K, where Z is the emulated impedance without the multiplication factor provided by the multiplier 902. Various embodiments utilizing the multiplier 902, and control of the same, are explained in further detail below.

In conventional droop control, the power feedback for the droop curve is calculated from current and voltage sensors at the output of the inverter. In other words, the current and voltage used for power calculation are actual output/load parameters. Because sensing the actual output/load voltages/currents has various challenges as explained above, in some embodiments, a virtual current that represents the output current of the inverter is calculated using the control approach as explained above.

In embodiments in which the bandwidth of the current controller of the inner loop 920 is sufficiently larger (e.g., >10 times) than that of the voltage controller 912 of the outer loop 910, then the inner current loop can be modelled as a unity follower circuit that follows the current reference generated by the voltage controller 912. Also, the bandwidth of the voltage controller 912 will typically be greater than the bandwidth of droop control, which may be in the range of 0.1 to 10 Hz.

Because the bandwidth (and thus dynamic responses) of the voltage and current loops are greater than that of the droop control loop, the voltage and current loops can also be modelled as unity follower circuits and safely assumed to follow the reference frequency/voltage set by droop curves of the droop control loop.

Implementing the nested loop structure (e.g., of FIG. 9) with droop control simplifies the control design, because the outer voltage/inner current loops 910, 920 are modelled as gain circuits. This feature of the nested loop can be used to estimate power/current output of the inverter. FIG. 10 is a schematic illustration of an approximation 1000 of the inner current loop in the control loop 900 of FIG. 9 in accordance with an embodiment of the present disclosure. Because the inner current loop 920 follows the reference set by the outer voltage loop 910, the inner current loop 920 can be modelled as a gain (determined by the current sensing and conditioning circuits), as shown in FIG. 10.

In a situation in which the transient current output of the inverter is different than the current reference, such difference is likely to be relatively small, and thus any effect on the power calculation for droop control feedback can generally be ignored, because droop control operates at a much lower bandwidth compared to that of the current controller. Thus, it can be safely approximated that the current reference I_{ref} is a scaled version of the actual output current (Iₒᵤₜ) for its usage in power calculation for droop control feedback.

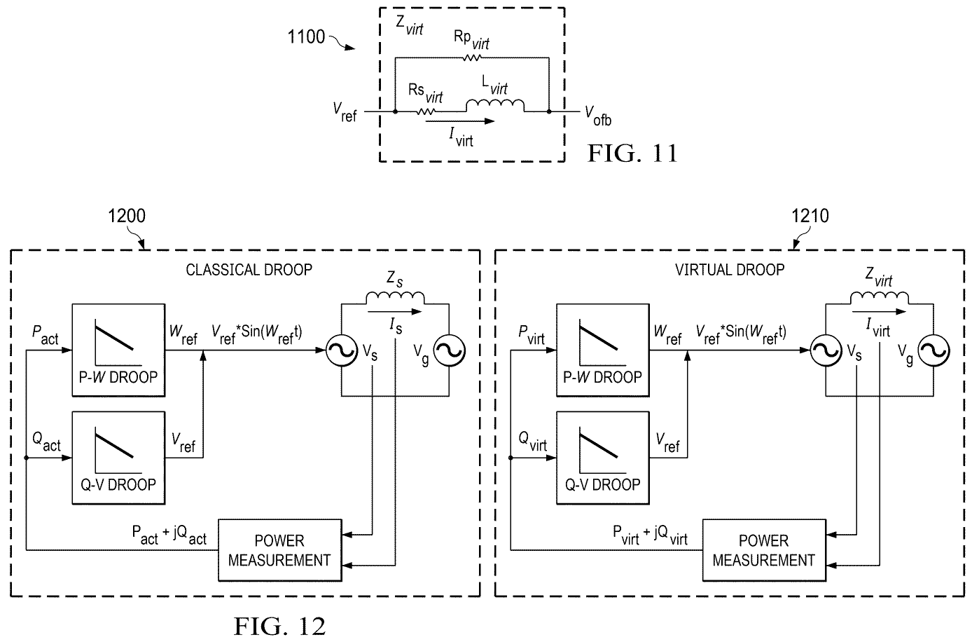

FIG. 11 is a circuit model of an effective virtual impedance network 1100 in accordance with an embodiment of the present disclosure. As described above, the voltage controller can be modeled as a virtual output impedance, which can be modified to include other impedance elements of the inverter, such as output electromagnetic interference (EMI) filters, cables, transformers, and the like. Using the effective virtual impedance network 1100, the current flowing through the network 1100 (Iᵥᵢᵣₜ) can be calculated, which closely matches the output current of the inverter.

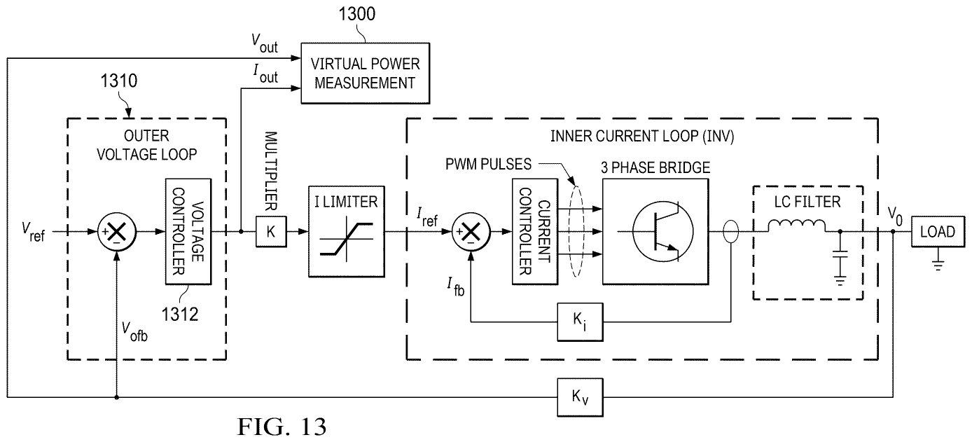

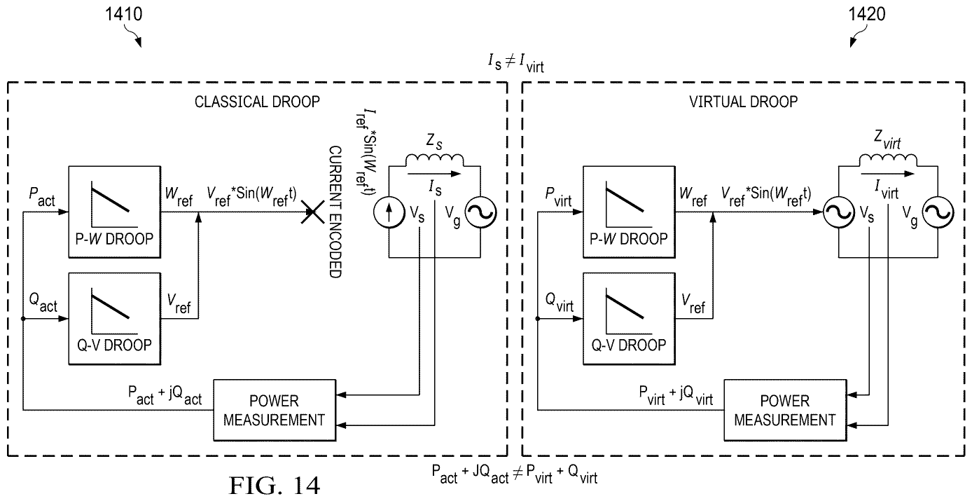

FIG. 12 is a schematic illustration comparing conventional droop control 1200 with virtual droop control 1210 in accordance with an embodiment of the present disclosure. The virtual current calculated using virtual impedance, described above, can be used to calculate virtual power as given by Equation 12, which is introduced in further detail below. This virtual power closely matches the actual output power of the inverter, and may thus be used as a feedback to the droop control instead of the actual power to eliminate the dependency on the output current sensor. Accordingly, in FIG. 12, the difference between the virtual droop control 1210 and the conventional droop control 1200 is that the virtual droop control 1210 uses feedback power calculated based on the actual inverter output voltage and the virtual current estimated using the impedance model described above. That is, the virtual droop control 1210 does not depend on actual current measurement from an output current sensor, which in turn enables the elimination of such output current sensor(s) in at least some embodiments.

As explained, unlike synchronous machines, inverters are current limited and the assumed voltage source model (e.g., as shown in FIG. 4) for droop control holds true only until the inverter hits the current limit (e.g., during overload or current limit conditions), at which point synchronization with other connected sources may be lost. This is primarily because the inverter current loop does not follow the current reference set by the voltage loop under such current limiting conditions, or the voltage control loop is limited to a predefined saturation/limit value. As a result, the voltage controller and thereby the emulated impedance of the inverter behave non-linearly.

Virtual droop control addresses such risk because the assumed voltage source model remains valid under such overload conditions, because the current feedback used for the power measurement is a virtual current. FIG. 13 is a schematic illustration of virtual power measurement 1300 in accordance with an embodiment of the present disclosure. As shown, the virtual power measurement 1300 receives the feedback voltage V_{0fb}, which is derived from the output voltage of the inverter. However, instead of receiving a sensed, actual output current, the virtual power measurement 1300 receives the virtual current provided by the PI controller 1312 in the outer voltage loop 1310.

Also, the virtual current reflects the output impedance of the inverter, and thus is not limited by inverter hardware. In some cases, the actual current/power measurement may not exactly match the calculated virtual current/power under such conditions (e.g., overload or current limit conditions). However, even in such cases, the voltage source model remains valid because the fact that the inverter may operate in a current-limited mode is not reflected in the virtual current measurement, and thus droop control is applicable to maintain synchronization, even under overload conditions. In other words, the current measurement is effectively taken before the current controller or hardware-imposed current limits, and thus the droop control model remains linear.

For example, FIG. 14 is a schematic illustration comparing conventional droop control 1410 with virtual droop control 1420 in current limiting mode in accordance with an embodiment of the present disclosure. In the conventional droop control 1410 example, the droop control is invalid when the inverter operates as a current source. By contrast, in the virtual droop control 1420, the power measurement is based on the calculated virtual current, and thus remains valid even under overload/short circuit conditions. Various embodiments of the present disclosure may leverage the ability of virtual droop control to maintain synchronization even under such current limit conditions to independently control the impedance of the source to limit and remain synchronized with the AC bus of the grid/microgrid.

An inverter under current limiting operation can be modelled as a voltage source in series with a variable impedance, depending on a load (in case of voltage sources connected to the load) or on the phase shift and the voltage difference between the source and a grid/microgrid (in case of voltage sources connected to grid/microgrid). However, this series impedance tends to be non-linear (e.g., impedance versus load) in the case of voltage controllers that have saturation limits which are implemented either digitally or using analog circuits. FIG. 15 is a circuit model of an analog implementation of a PI controller 1500 (e.g., op amp-based) having pre-defined saturation limits.

The PI controller 1500 implements parameters such as Kₚ and Kᵢ using the passive resistors Rᵢ, Rₚ and the capacitor Cᵢ. The breakdown values of Zener diodes D1 and D2 determine the positive and negative saturation limits of the PI controller 1500. For inverter/grid connected applications, both signals V_{ref} and V_{ofb} are sinusoidal in nature. As the output of the PI controller 1500 reaches the breakdown voltage of the Zener pair, the output is clamped and the current reference to the current controller is thus limited. Under such conditions, the linear relation between the error (i.e., V_{ref}−V_{ofb}) and the output of the error amplifier is no longer valid. Modeling the emulated impedance is difficult because the circuit 1500 is non-linear in this scenario.

As explained above, introducing the multiplication factor K after the PI controller (as introduced in FIG. 9) only changes the magnitude of the emulated impedance, and does not affect the phasor of the emulated impedance. The relation between the apparent power export of the inverter and the emulated impedance can be derived as follows. First, squaring and summing Equations 3 and 4 gives:

$${P}^{2} + {Q}^{2} = {( \frac{E * {V}_{g} sin ( δ - {δ}_{g} ) )}{{X}_{g}} )}^{2} + {( \frac{{V}_{g} * ( E cos ( δ - {δ}_{g} ) - {V}_{g} )}{{X}_{g}} )}^{2} \qquad Equation 12$$

Approximating cos(δ−δ_{g})˜1 for small values of (δ−δ_{g}) gives:

$${P}^{2} + {Q}^{2} = {( \frac{E * {V}_{g}}{{X}_{g}} )}^{2} * {( 1 - \frac{E}{{V}_{g}} )}^{2} \qquad Equation 13$$

Substituting P²+Q²=S² in Equation 13 gives:

$$S = ( \frac{E * {V}_{g}}{{X}_{g}} ) * ( 1 - \frac{E}{{V}_{g}} ) \qquad Equation 14$$

Where S is the apparent power exported by the inverter. From Equation 14, the power export is inversely proportional to the impedance, and thus the total current is also inversely proportional to the impedance:

$$S ∝ \frac{1}{{X}_{g}} ⇒ {I}_{i n v} ∝ \frac{1}{{X}_{g}} \qquad Equation 15$$

$${X}_{g} ∝ \frac{1}{K} ⇒ {I}_{i n v} ∝ K$$

As explained above, the impedance is inversely proportional to the multiplication factor K (i.e., the multiplication factor K effectively proportionally reduces the parameters Kₚ and Kᵢ of the PI controller, which increases the emulated impedance by the same factor). Accordingly, the inverter current is linearly related to the multiplication factor K, and can thus be directly controlled by controlling K. In other words, the multiplication factor K directly controls the output current of the inverter (through emulated impedance), and thus also controls the power exported by the inverter.

In various embodiments described herein, controlling the multiplication factor K during overload conditions may limit the inverter current from hitting the saturation limits described above, which maintains the linear relationship between the source voltage and output current through the duration of the overload/short circuit condition. This same control scheme may be applied to control active and reactive power instantaneously (e.g., by considering (δ−δ_{g}) and the voltages to be momentarily constant).

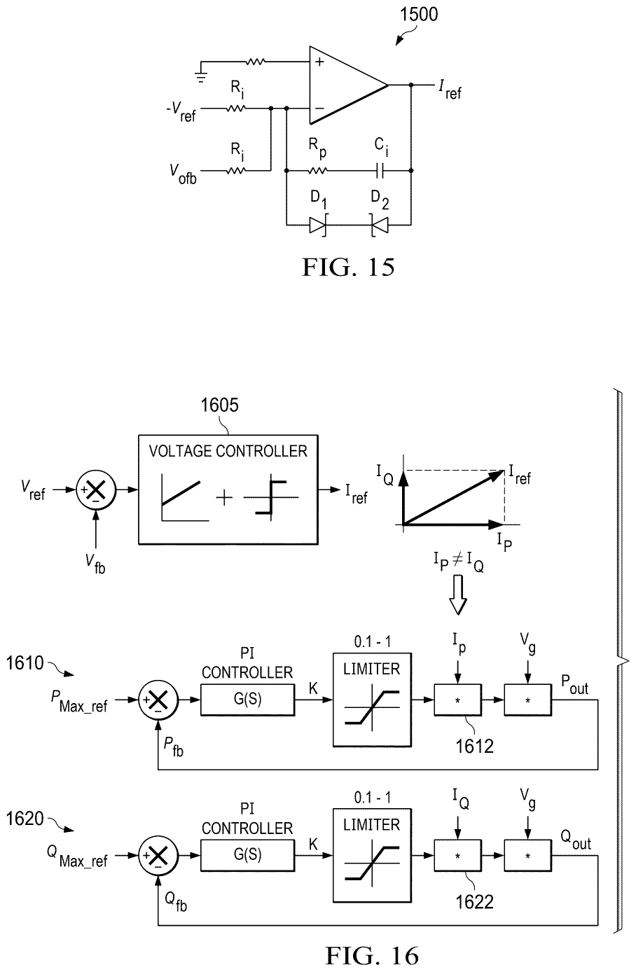

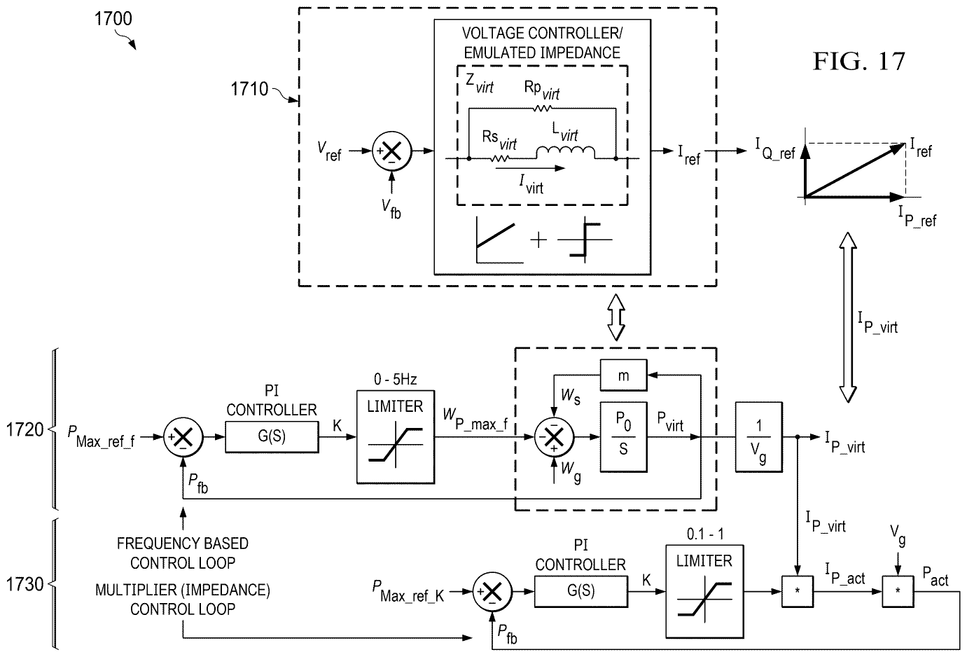

FIG. 16 is a schematic illustration of such an active power control loop 1610 and reactive power control loop 1620, using the multiplier (K) in accordance with an embodiment of the present disclosure. In FIG. 16, Iₚ and I_{q} are the active and reactive components of a current reference, respectively, which is generated by the voltage controller 1605. The voltage controller 1605 may be similar to the voltage controller 910 in FIG. 9. As the multiplier loops 1612, 1622 directly scale down the current reference generated by the voltage controller 1605, the gain of the controller 1605 is reduced, and thus the emulated impedance increases proportionally. This increase in impedance limits the current/power to the desired value (e.g., P_{max_ref} and Q_{max_ref}).

In some examples, the bandwidth of the multiplier loops 1612, 1622 is designed to be significantly greater than (e.g., >10 times) the power loops 1610, 1620 controlled through droop control, for the assumption that the phase (δ−δ_{g}) and voltage differences (E−V_{g}) are momentarily constant. In other words, such phase and voltage differences act as disturbances that can be rejected due to the high bandwidth of multiplier loops 1612, 1622.

The following presents an example of fault recovery using decoupled control in accordance with embodiments of the present disclosure. In particular, as explained above, short circuit and overload conditions create phase/frequency shifts between paralleled sources. In situations in which the short circuit condition is sustained (e.g., duration>2 sec), the phase shifts between the connected sources may be significant (e.g., between +/−180° if the no load frequencies are different), causing proportionally significant power circulation, thereby resulting in microgrid failures upon recovery from the short circuit condition. The bandwidth of various loops (e.g., power control, DC bus control) associated with frequency control by adjusting droop curve offsets are limited. This limitation on bandwidth is because of the droop control bandwidth constraints described above. Accordingly, controlling the circulating power/DC bus voltages under such recoveries or phase shifts is difficult using conventional droop control.

As described, virtual droop control decouples the effect of source impedance on droop control bandwidth, and thus also eliminates or otherwise reduces the dependency of frequency-based loops on impedance. This feature can be leveraged by the multiplier (impedance) control loops under such sudden phase/frequency shifts that may occur during fault recoveries. The ability to design the bandwidth of the multiplier loops to be greater than the bandwidth of other frequency-based control loops, the multiplier loops may limit the power export/import during such transients, while the frequency-based control loops correct for phase/frequency shifts. This reduces the likelihood of the system tripping because of overload or DC bus undervoltage (UV)/overvoltage (OV) faults, enabling a safe recovery after fault conditions.

An example of a phase shift created during a short circuit condition and the operation of frequency-based and multiplier loops in tandem to recover from such fault is explained below. In this example, the inverter source is connected to a grid/microgrid as shown in FIG. 1. The following conditions exist before a bolted short circuit condition occurs at the terminals of the inverter source (i.e., inverter 102 in FIG. 1):
The inverter 102 is operating at its rated power prior to the fault at a unity power factor;
Impedance of the inverter 102 is 10% (i.e., 0.1 pu) and is purely inductive;
Frequency of the grid 104 is 60 Hz;
The no load and full load set points for a droop curve for the inverter 102 are 60.5 Hz and 60 Hz, respectively (i.e., 0.5 Hz droop slope), with full load power being 1 pu;
The maximum power that the inverter 102 can support continuously is 1.5 pu; and.
The duration of the short circuit condition is 0.5 seconds.

In a bolted short circuit, the output voltage of the inverter 102 is zero, and thus the inverter 102 power is also zero. Accordingly, the inverter 102 operating frequency is the no load frequency of 60.5 Hz. Because the grid/microgrid 104 frequency is 60 Hz, a frequency difference exists during the short circuit condition, which results in phase integration. The corresponding phase difference between the grid/microgrid 104 and the inverter 102 at the end of the short circuit is given as:

$$δ - {δ}_{g} = \int ( {ω}_{s} - {ω}_{g} ) d t \qquad Equation 16$$

Substituting (ωₛ−ω_{g})=2*π*0.5, and T=0.5 S gives:

$$δ - {δ}_{g} = \frac{π}{2} \qquad Equation 17$$

The accumulated phase shift between the inverter 102 and the grid 104 at the end of the short circuit is π/2 radians. Accordingly, the active power exported by the inverter 102 to the grid 104 immediately after recovery of the short circuit condition is:

$$P = \frac{E * {V}_{g} sin ( δ - {δ}_{g} ) )}{{X}_{g}} \qquad Equation 18$$

Substituting magnitudes of E and Vg as 1 pu, X_{g}=0.1 pu, and

$$δ - {δ}_{g} = \frac{π}{2} ,$$

the active power export is given by:

$$P = \frac{1 * 1 * sin ( \frac{π}{2} )}{0.1} \qquad Equation 19$$

$$P = 10 pu$$

From Equation 19, the expected active power export by the inverter 102 at the instant of fault recovery is 10 pu, which is much greater than its maximum power of 1.5 pu. Accordingly, the inverter 102 may hit its current limit, or experience a collapse in the DC bus due to the high amount of active power the inverter 102 pumps to the grid/microgrid 104. Any of these conditions may eventually result in tripping the inverter 102, which is not desirable.

FIG. 17 is a schematic block diagram 1700 of maximum power frequency and multiplier loops in accordance with an embodiment of the present disclosure. FIG. 17 illustrates the operation of frequency-based and multiplier-based maximum power (P_max) loops of the inverter, employed in tandem with virtual droop control as described above. In particular, the block diagram 1700 includes a virtual impedance/PI controller 1710, which is similar to the voltage controller 910 in FIG. 9, and thus provides a virtual current (e.g., to be used by an inner loop as a reference current input). The block diagram 1700 also includes a frequency-based control loop 1720, and a multiplier (impedance)-based control loop 1730.

In FIG. 17, the frequency-based control loop 1720 operates on virtual current/power as feedback, which is obtained from the virtual impedance/PI controller 1710, and is thus unaffected by the multiplier-based control loop 1730. At the same time, the power feedback for the multiplier-based control loop 1730 is the actual power exported by the inverter (P_{act}), which may be obtained by multiplying the virtual power/current by the multiplier value K:

$${P}_{virt} = \frac{E * {V}_{g} sin ( δ - {δ}_{g} ) )}{{X}_{v i r t}} \qquad Equation 20$$

$${P}_{act} = K * {P}_{virt} \qquad Equation 21$$

Imposing the above short circuit recovery condition on the P_max loops, the virtual power calculated just after recovery from the short circuit condition is 10 pu, which is equal to the actual power exported by the inverter for K=1.

Because the maximum continuous power export capacity of the inverter is 1.5 pu, the loop reference values for the multiplier-based control loop 1730 and the frequency-based control loop 1720 (i.e., P_{max_ref_k} and P_{max_ref_f}, respectively) are set as 1.5 pu and 1.49 pu, respectively. In this example, the feedback power for both control loops 1720, 1730 exceeds these setpoints, and thus the control loops 1720, 1730 attempt to correct for the same. However, the frequency-based control loop 1720 bandwidth is lower than the multiplier-based control loop 1730 bandwidth, and thus the multiplier-based control loop 1730 reacts more quickly, limiting the power to 1.5 pu by controlling K.

In this example, just after the recovery from the short circuit, when the multiplier-based control loop 1730 limits the active power as described above, the value of the multiplier K can be estimated as:

$$K = \frac{{P}_{max \_ ref \_ k}}{{P}_{a c t}} = \frac{1.5 p u}{10 p u} = 0.15 \qquad Equation 22$$

Because of the relationship between the multiplier K and source impedance, described above, as the multiplier-based control loop 1730 limits the exported power by adjusting the value of K, the increased source impedance

$${X}_{g}^{\vert}$$

is given as:

$${X}_{g}^{\vert} = \frac{{X}_{g}}{K} = \frac{0.1 pu}{0.15} = 0.66 pu \qquad Equation 23$$

This increased impedance validates the power export through power swing equation. However, because the virtual impedance is matched with source emulated impedance, Xᵥᵢᵣₜ=X_{g}, the virtual power measurement Pᵥᵢᵣₜ is unchanged and will continue to measure 10 pu.

As a result, the frequency-based control loop 1720 corrects for the phase difference by adjusting the frequency. Because the frequency-based control loop 1720 reference (P_{max_ref_f}) is set lower (1.49 pu) than the multiplier-based control loop 1730 reference (P_{max_ref_K}), the frequency-based control loop 1720 will continue correcting for the phase until the Pᵥᵢᵣₜ reaches 1.49 pu. When Pᵥᵢᵣₜ reaches a value less than P_{max_ref_K}, the multiplier-based control loop 1730 starts increasing the value of K until K reaches its saturation value of 1. Under these conditions, the multiplier-based control loop 1730 is no longer effective, and the frequency-based control loop 1720 will govern inverter control until normal operation is restored.

Accordingly, it is important to set the references for the control loops 1720, 1730 so that the frequency-based control loop 1720 reference controls during steady-state operation. It is also useful to set the references for the control loops 1720, 1730 such that the difference therebetween is relatively small (e.g., 0.01 pu in this example), in order to provide a more seamless transition from the multiplier-based control loop 1720 controlling operation, to the frequency-based control loop 1720 controlling operation.

The embodiments described herein may also enable improved synchronization between an isolated inverter/source and a grid. For example, during transitions between grid-connected and islanded operations of a microgrid, it is important to synchronize with the grid before each transition. Failing to perform such synchronization may result in high circulating currents, because the loss of synchronization can create phase shifts between the grid and the microgrid. However, conventional droop control may fail to achieve such synchronization as explained above. The following examples explain the implementation of virtual droop control to achieve synchronization of an inverter/islanded microgrid with the grid when the two are decoupled.

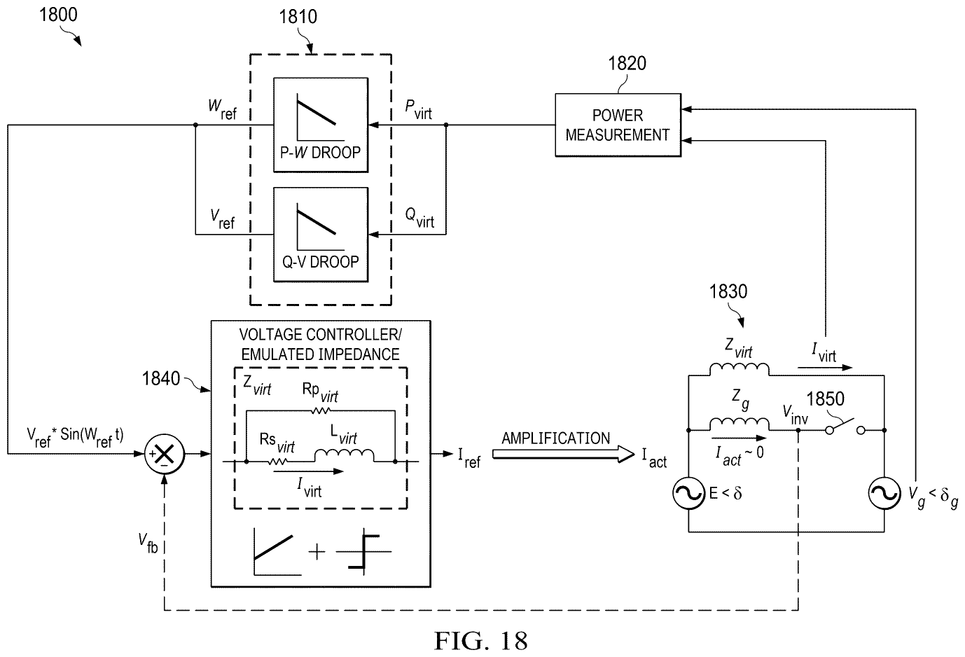

FIG. 18 is a schematic block diagram 1800 of initial synchronization enabled by virtual droop control in accordance with an embodiment of the present disclosure. As explained above, conventional droop control relies on a PLL for initial synchronization while connecting the inverter to a grid/microgrid. For example, an open circuit breaker between the sources provides an effective infinite impedance, which does not allow for any power flow, thus rendering conventional droop control ineffective for synchronization. However, the virtual droop control approaches described herein estimate the power between the sources using a virtual impedance. Accordingly, a virtual power flow exists even when the other source is disconnected or islanded. This virtual power flow can be used as the missing link in droop control to achieve synchronization.

In FIG. 18, the block diagram 1800 illustrates initial synchronization using virtual droop control. The block diagram 1800 includes a virtual droop controller 1810, which receives virtual power measurements from power measurement block 1820. Because the actual current flow/power is zero in the example of FIG. 18, the feedback path for conventional droop control is broken, as explained above.

However, the virtual droop controller 1810 estimates the current/power based on the phase shift between the sources by creating a virtual impedance network 1830 between the two sources. This provides the necessary feedback path for the virtual droop controller 1810 to synchronize with the grid/microgrid. The voltage and frequency references thus generated by the virtual droop controller 1810 are provided to the voltage controller 1840, which regulates the voltage before the circuit breaker 1850. In some examples, the current reference (I_{ref}) generated by the voltage controller 1840 is relatively small in value (e.g., supplying the no load current of the inverter), and is subsequently amplified by the current controller (not shown in FIG. 18 for simplicity) to the actual current (I_{act}). The following equations demonstrate relationships of FIG. 18:

$${I}_{virt} = \frac{E < δ - {V}_{g} < {δ}_{g}}{{Z}_{virt}} \qquad Equation 24$$

$${S}_{virt} = {V}_{g} {I}_{virt}^{*} = {P}_{virt} + {jQ}_{virt}$$

The voltage and frequency references generated by the virtual droop controller 1810 are given as:

$${W}_{ref} = {W}_{nl} - {m}_{P} * {P}_{virt} \qquad Equation 25$$

$${V}_{ref} = {V}_{nl} - {m}_{Q} * {Q}_{virt} \qquad Equation 26$$

Where Vₙₗ, m_{Q}, Wₙₗ, and m_{P} are the droop curve parameters.

Accordingly, because the droop controller 1810 is able to generate frequency and voltage references (w_{ref} and v_{ref}) that match the grid frequency and voltage (W_{g} and V_{g}) through closed loop, the inverter synchronizes with the grid. The virtual power (Pᵥᵢᵣₜ and Qᵥᵢᵣₜ) in this example corresponds to the power to be exported to grid given by substituting w_{ref}=W_{g} and v_{ref}=Vgin Equations 25 and 26, respectively.

If the virtual impedance (Zᵥᵢᵣₜ) matches actual impedance (Z_{g}), then the power exported by the inverter when the circuit breaker is closed (e.g., after virtual droop synchronization is achieved) will match Pᵥᵢᵣₜ and Qᵥᵢᵣₜ. It should be appreciated that virtual droop control thus creates the required phase shift and voltage difference in the inverter voltage reference to export the predetermined active and reactive power to the grid during the initial synchronization, which in turn eliminates the need for a separate PLL for initial synchronization.

FIG. 19 is a schematic illustration of virtual droop control operation before (1910) and after (1920) closing a circuit breaker (e.g., circuit breaker 1850 in FIG. 18) coupled to a grid-forming inverter in accordance with an embodiment of the present disclosure. Referring to FIGS. 18 and 19, it should be understood that the voltage feedback to the voltage controller 1840 is from the inverter side of the circuit breaker 1850, while the virtual current calculation is from the grid side of the circuit breaker 1850. This is important in applying virtual droop control for the initial synchronization process, described above. Once initial synchronization is achieved and the circuit breaker 1850 is closed, the virtual droop controller 1810 will implement classical droop control operation as illustrated in 1920 in FIG. 19.

In some embodiments, the above-described approach to synchronize the inverter to a grid/microgrid prior to connection thereto can be extended to synchronize an inverter or an islanded microgrid to an isolated/disconnected source or grid. For example, it is assumed that an inverter or a microgrid connected to load operating as an island is disconnected from the grid via a circuit breaker. If the inverters (or the paralleled sources) in the microgrid are operating in droop control mode, it is difficult to achieve continuous synchronization with the grid because the frequency of the microgrid varies continuously based on its load.

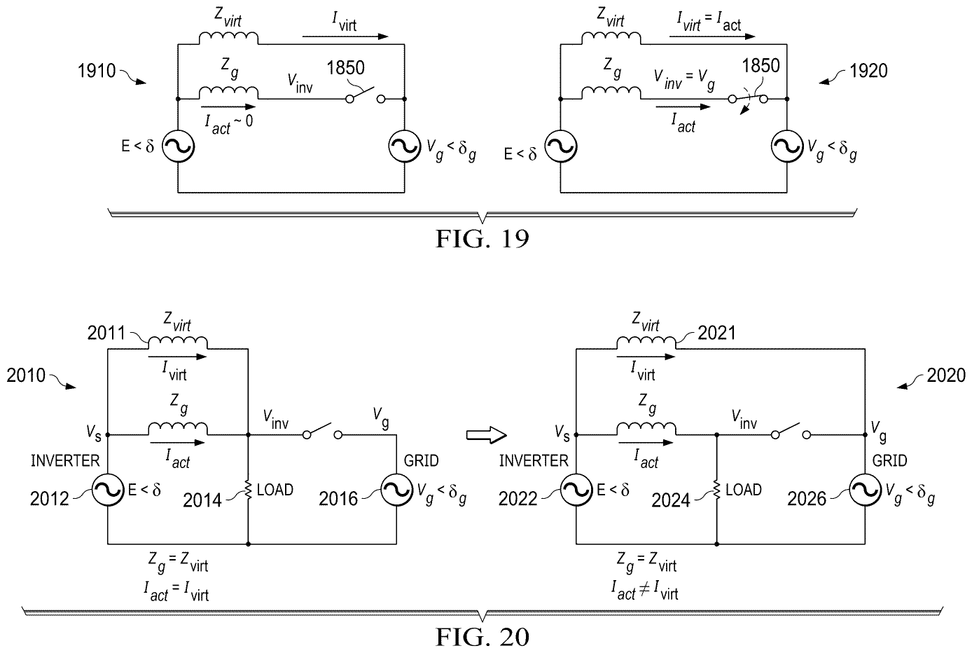

FIG. 20 is a schematic illustration of a virtual impedance network on an isolated grid in accordance with an embodiment of the present disclosure. In FIG. 20, a first implementation 2010 illustrates a virtual impedance network 2011 connected between an islanded inverter/microgrid 2012 and a load 2014. Using the resultant virtual power for droop control will synchronize the inverter/microgrid 2002 with the grid 2004. In FIG. 20, a second implementation 2020 illustrates a virtual impedance network 2021 connected between an islanded inverter/microgrid 2022 and a grid 2026. In the second implementation 2020, the islanded inverter/microgrid 2022 is connected to a load 2024, but isolated from the grid 2026. Thus, the virtual impedance network 2021 enables the islanded inverter/microgrid 2022 to be synchronized with the isolated grid 2026 prior to being coupled to the grid 2026.

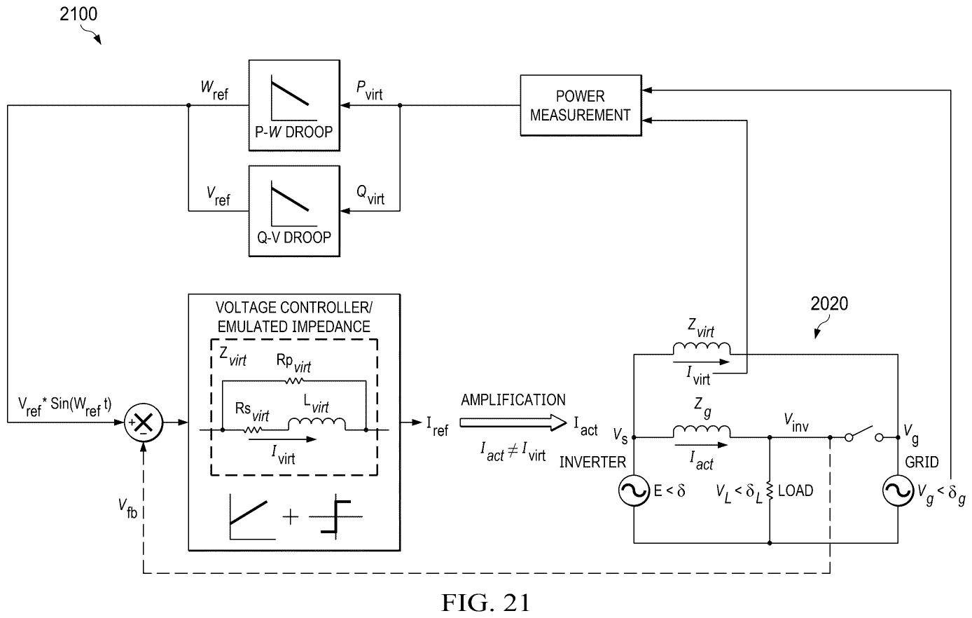

FIG. 21 is a schematic illustration of virtual droop control implemented on an isolated source/grid in accordance with an embodiment of the present disclosure. FIG. 21 schematically illustrates the control loop 2100 associated with the second implementation 2020 of FIG. 20. That is, instead of the virtual impedance network being connected between the inverter source and the load (i.e., as in the first implementation 2010 of FIG. 20), the virtual impedance network is connected between the inverter and the isolated grid. As a result, the virtual droop control is implemented on this modified model to achieve synchronization with the isolated grid, prior to the inverter being coupled thereto.

The power flow and the droop equations for FIG. 21 follow Equations 24-26, above, and the inverter source voltage synchronizes with grid voltage through the closed loop droop control. However, in the example of FIG. 21, the virtual power and actual power readings may not match because the virtual power follows the droop curves and matches the power requirements based on grid voltage and frequency. For example, the calculated virtual power and the actual power delivered to the load can be given as:

$${I}_{virt} = \frac{E < δ - {V}_{g} < {δ}_{g}}{{Z}_{virt}} \qquad Equation 27$$

$${S}_{virt} = {V}_{g} {I}_{virt}^{*} = {P}_{virt} + {jQ}_{virt} \qquad Equation 28$$

$${I}_{act} = \frac{E < δ - {V}_{L} < {δ}_{L}}{{Z}_{g}} \qquad Equation 29$$

$${S}_{act} = {V}_{g} {I}_{act}^{*} = {P}_{act} + {jQ}_{act} \qquad Equation 30$$

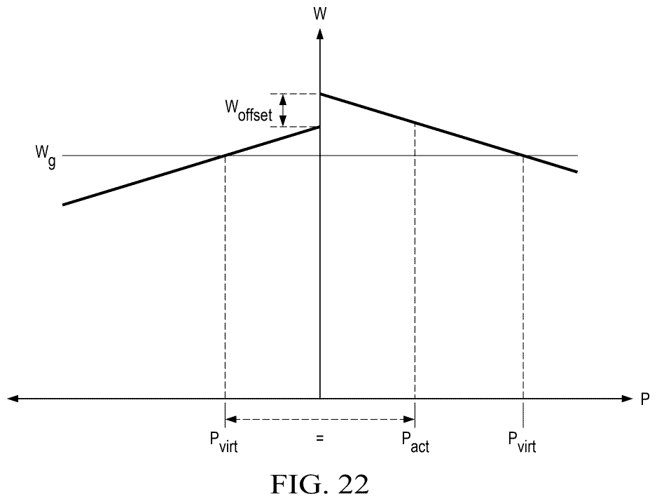

FIG. 22 is a graphical illustration of power control through offset adjustment. For example, because the virtual droop control is implemented based on grid voltage, the calculated virtual power thus follows the intersection of the grid frequency with the droop curves. By adjusting the droop curves with the required offset, the virtual power can be matched with the actual power as shown in FIG. 22. When the virtual power is matched with the actual power, the corresponding load voltage Vᵢₙᵥ can be back-calculated using Equations 28 and 30 as:

$${S}_{virt} = {S}_{act} ⇒ {V}_{g} {I}_{virt}^{*} = {V}_{g} {I}_{act}^{*} ⇒ {I}_{virt} = {I}_{act} \qquad Equation 31$$

For Zᵥᵢᵣₜ=Z_{g}, equating Equations 27 and 29 gives:

$$⇒ {V}_{inv} = {V}_{g} < {δ}_{g} \qquad Equation 32$$

From the above Equation 32, the inverter/microgrid load voltage Viny matches the grid voltage when virtual power is matched with actual load power. This allows more seamless transition from islanded operation to grid-connected operation when closing the circuit breaker.

By implementing the virtual droop control with respect to grid voltage (rather than between the connected/paralleled sources of the microgrid), the power circulation between the connected sources of the microgrid will not be considered, which may disturb the power sharing between the connected sources momentarily. However, the transition between islanded and grid-connected only persists on the order of a few seconds in most cases, and thus the power sharing differences for such relatively small durations may be tolerated in the interest of achieving the enhanced synchronization abilities provided by such virtual droop control.

In the virtual droop control embodiments described herein, the dependency of droop control on output impedance of the inverter is eliminated. Accordingly, the droop stability criteria can be independently controlled, and are given as:

$$\frac{E * {V}_{g}}{{X}_{virt}} * m * {T}_{update} < 1 \qquad Equation 33$$

As described above, Xᵥᵢᵣₜ is digitally controlled, and thus can be dynamically varied based on the droop slope (m) requirement. For example, for microgrid requirements for larger droop slopes, the virtual impedance Xᵥᵢᵣₜ can be proportionally increased to satisfy the stability criteria expressed above.

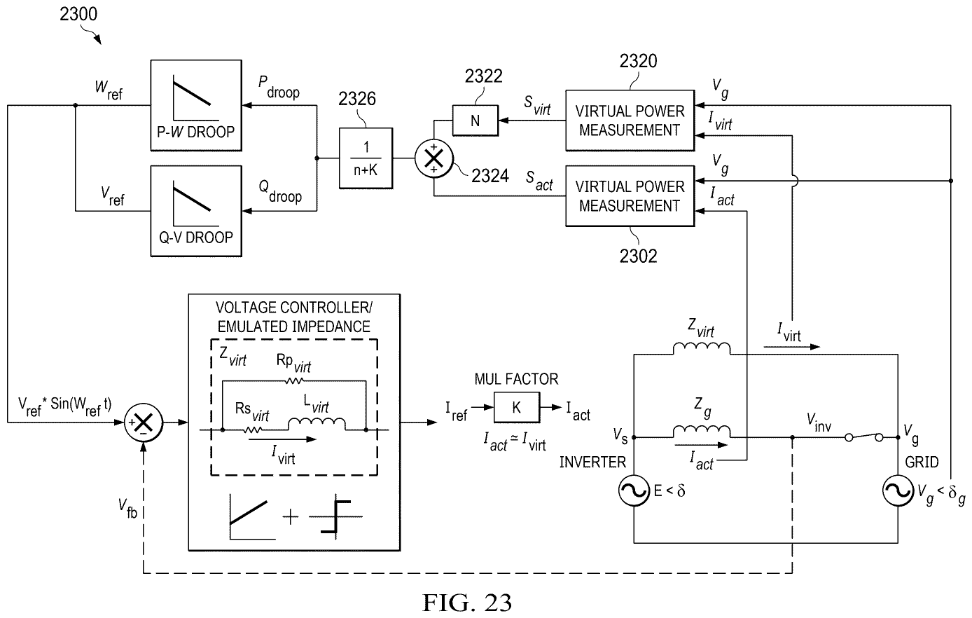

FIG. 23 is a schematic illustration of hybrid droop control 2300 in accordance with an embodiment of the present disclosure. As explained, digitally implementing virtual droop control may result in mismatches between the actual and virtual impedances (or phase shifts/delays between the actual and sensed voltages), which correspond to mismatches between actual and virtual power measurements. In some examples this may be undesirable, particularly for parallel operation of similar sources where equal power sharing is a priority.

In the embodiments described herein, virtual droop control is particularly advantageous due to it being a decoupled control when source impedance is varied, such as during fault conditions. The hybrid droop control 2300 of FIG. 23 thus combines aspects of conventional and virtual droop control to provide a tunable solution for certain applications.

FIG. 23 is generally similar to FIGS. 18 and 21, except that an actual power measurement 2302 is combinable with virtual power measurement 2320. The actual power measurement 2302 is based on the inverter output current and voltage (i.e., the inverter output power). In particular, the virtual power measurement 2320 is multiplied by n (block 2322), summed with the actual power measurement (2302) (block 2324), and divided by the quantity n+K (block 2326). The power result of block 2326 is then provided to the droop controller, and the remainder of FIG. 23 functions similarly to FIG. 18, for example.

Thus, the hybrid droop control model 2300 calculates both the actual power (2302) and virtual power (2320), and the power feedback to droop curves (S_{droop}) is given as:

$${S}_{droop} = \frac{{S}_{act} + n * {S}_{virt}}{n + K} \qquad Equation 34$$

In this example, n is in the range 0<n<1 and is the adjustment factor for virtual power, while K is the multiplication factor explained above. The active power and reactive power are scaled accordingly, and can be given as:

$${P}_{droop} = \frac{{P}_{act} + n * {P}_{virt}}{n + K} \qquad Equation 35$$

$${Q}_{droop} = \frac{{Q}_{act} + n * {Q}_{virt}}{n + K} \qquad Equation 36$$

The adjustment factor n thus mitigates the effect of error between actual power and virtual power upon power sharing. For example, let ‘e’ be the error factor between actual and virtual powers

$$( e = \frac{{P}_{act} - {P}_{virt}}{{P}_{act}} ) ,$$

and then the error between the droop power and actual power can be given as:

$${P}_{droop} = \frac{{P}_{act} + n * ( 1 - e ) * {P}_{act}}{n + K} \qquad Equation 37$$

$${P}_{droop} = \frac{{P}_{act} * ( 1 + n - ne )}{n + K}$$

For K=1 (e.g., under normal operation):

$$\frac{{P}_{act} - {P}_{droop}}{{P}_{act}} = \frac{ne}{n + 1} \qquad Equation 38$$

Because n<1, particularly for smaller values of n (e.g., n=0.1, 0.2),

$$\frac{n}{n + 1}$$

can be approximated as n. Thus, the error between the droop power and actual power can be mitigated by a factor of n. For a case where the multiplier loop varies the value of K, considering negligible error between actual and virtual powers, for e<<1, Equation 35 can be modified as:

$${P}_{act} ≃ K * {P}_{virt} \qquad Equation 39$$

$${P}_{droop} ≃ \frac{K * {P}_{virt} + n * {P}_{virt}}{n + K}$$

$${P}_{droop} ≃ \frac{{P}_{virt} ( n + K )}{n + K}$$

$${P}_{droop} ≃ {P}_{virt}$$

Accordingly, under the influence of the multiplier loop acting to vary K, P_{droop}≅Pᵥᵢᵣₜ and virtual power takes precedence over actual power as desired.

In view of the foregoing description, it should be appreciated that a controller for an inverter may implement some or all of the above control loops, which utilize an emulated or virtual impedance to in turn calculate a virtual current and/or virtual power for the inverter. The various control loops described herein thus limit circulating power during recovery from short circuit/overload conditions, and provide enhanced synchronization with a grid upon fault recovery (e.g., prior to closing a circuit breaker to couple the inverter to that grid). Further, the set points (e.g., reference or threshold values) of the various control loops implemented by the controller for the inverter may be set such that all of the implemented loops function independently of and without interfering with one another.

Accordingly, in one embodiment, a microgrid includes a power source, such as a fuel cell, solar panels, or the like, and an inverter electrically coupled thereto. The microgrid also includes a load, to which the inverter provides an output or load power. The inverter includes a controller configured to implement some or all of the control loops, utilizing emulated impedance and calculated virtual current and/or virtual power, described above.

While several embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

While several embodiments have been provided, the disclosed systems and methods may be embodied in other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented. Likewise, where single components, apparatuses, or systems are described as performing functions, multiple such components, apparatuses, or systems may implement the functions.

The term “about” means a range including ±10% of the subsequent number unless otherwise stated. Where single components, apparatuses, or systems are described as performing functions, multiple such components, apparatuses, or systems may implement the functions.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

1. A method, comprising:
applying a first proportional gain constant (Kₚ₁) and a first integral gain constant (Kᵢ₁) to a difference based on a reference voltage and an output voltage of an inverter to generate a virtual current signal for an inner current loop, wherein Kₚ₁ is associated with a resistive component of an emulated impedance, and wherein Kᵢ₁ is associated with an inductive component of the emulated impedance; and
controlling the output voltage of the inverter based on the virtual current signal.

2. The method of claim 1, further comprising:
multiplying the virtual current signal by a multiplication factor (K) to generate a scaled virtual current signal; and
controlling the output voltage of the inverter based on the scaled virtual current signal.

3. The method of claim 2, wherein the multiplication factor K is configured to control the emulated impedance of the inverter.

4. The method of claim 2, further comprising controlling K to limit an output current of the inverter during an overload or short circuit condition.

5. The method of claim 1, further comprising:
generating a virtual power signal based on the virtual current signal and the output voltage of the inverter; and
providing the virtual power signal to a droop controller to control an output frequency of the inverter and the output voltage of the inverter.

6. The method of claim 5, further comprising:
multiplying the virtual current signal by a multiplication factor (K) to generate a scaled virtual current signal; and
controlling the output voltage of the inverter based on the scaled virtual current signal,
wherein the droop controller is decoupled from a loop that applies the multiplication factor K.

7. The method of claim 1, further comprising:
generating a virtual power signal based on the virtual current signal and a grid voltage when the inverter is electrically decoupled from the grid; and
providing the virtual power signal to a droop controller to control an output frequency of the inverter and the output voltage of the inverter.

8. The method of claim 7, further comprising electrically coupling the inverter to the grid in response to:
the output frequency of the inverter being approximately equal to a grid frequency; and
the output voltage of the inverter being approximately equal to the grid voltage.

9. The method of claim 7, wherein the emulated impedance is between a terminal of the inverter and a terminal of the grid, or wherein the emulated impedance is between a terminal of the inverter and a terminal of a load coupled to the inverter.

10. The method of claim 1, further comprising:
generating a virtual power signal (Sᵥᵢᵣₜ) based on the virtual current reference signal and the output voltage of the inverter;
measuring an output power of the inverter (S_{act});
generating a combined power signal (S_{droop}) according to:
$${S}_{droop} = \frac{{S}_{act} + n * {S}_{virt}}{n + K} ,$$
wherein n is an adjustment factor for the virtual power signal, and K is a multiplication factor applied to the virtual current reference signal; and
providing the combined power signal to a droop controller to control an output frequency of the inverter and the output voltage of the inverter.

11. The method of claim 1, wherein the virtual current reference signal is generated without a current sensor.

12. A method, comprising:
applying a first proportional gain constant (Kₚ₁) and a first integral gain constant (Kᵢ₁) to a difference based on a reference voltage and an output voltage of an inverter to generate a virtual current signal, wherein Kₚ₁ is associated with a resistive component of an emulated impedance, and wherein Kᵢ₁ is associated with an inductive component of the emulated impedance;
providing the virtual current signal to a frequency-based control loop, wherein the frequency-based control loop controls a frequency of the inverter based on the virtual current signal and a first reference power value; and
providing the virtual current signal to a multiplier-based control loop, wherein the multiplier-based control loop controls an output power of the inverter based on the virtual current signal and a second reference power value.

13. The method of claim 12, wherein a bandwidth of the multiplier-based control loop is greater than a bandwidth of the frequency-based control loop.

14. The method of claim 13, wherein the bandwidth of the multiplier-based control loop is at least ten times greater than the bandwidth of the frequency-based control loop.

15. The method of claim 12, wherein the first reference power value is less than the second reference power value.

16. A microgrid, comprising:
a power source;
a load; and
an inverter electrically coupled to the power source and configured to provide an output voltage to the load, wherein the inverter comprises a controller configured to:
apply a first proportional gain constant (Kₚ₁) and a first integral gain constant (Kᵢ₁) to a difference based on a reference voltage and the output voltage of the inverter to generate a virtual current reference signal for an inner current loop of the controller, wherein Kₚ₁ is associated with a resistive component of an emulated impedance, and wherein Kᵢ₁ is associated with an inductive component of the emulated impedance; and
control the output voltage of the inverter based on the virtual current signal.

17. The microgrid of claim 16, wherein the controller is further configured to:
multiply the virtual current signal by a multiplication factor (K) to generate a scaled virtual current signal; and
control the output voltage of the inverter based on the scaled virtual current signal.

18. The microgrid of claim 17, wherein the multiplication factor K is configured to control the emulated impedance of the inverter.

19. The microgrid of claim 17, wherein the controller is further configured to control K to limit an output current of the inverter during an overload or short circuit condition.

20. The microgrid of claim 16, wherein the controller is further configured to:
generate a virtual power signal based on the virtual current signal and the output voltage of the inverter, and
provide the virtual power signal to a droop controller to control an output frequency of the inverter and the output voltage of the inverter.
